(19) United States
(12) Patent Application Publication
(10) Pub. No.: US 2026/0346463 A1
(43) Pub. Date: Nov. 5, 2026

(54) CONTROL DEVICE, CONTROL METHOD FOR ROBOT SYSTEM, AND ROBOT CONTROL SYSTEM

(71) Applicant: PANASONIC INTELLECTUAL PROPERTY MANAGEMENT CO., LTD., Osaka (JP)

(72) Inventors: Daiki MURAKAMI, Osaka (JP); Kiyoshi SANO, Kanagawa (JP); Michitaka SAKON, Kanagawa (JP); Masanari MORISHITA, Osaka (JP)

(73) Assignee: PANASONIC INTELLECTUAL PROPERTY MANAGEMENT CO., LTD., Osaka (JP)

(21) Appl. No.: 19/547,033

(22) Filed: Feb. 23, 2026

(30) Foreign Application Priority Data
May 2, 2025 (JP) 2025-076921

(51) Int. Cl. B25J 9/16; G06T 7/20; G06T 7/80; G06V 20/64; H04N 23/61

(52) U.S. Cl. CPC B25J 9/1697; B25J 9/163; G06T 7/20; G06T 7/80; G06V 20/64; H04N 23/61; G06V 2201/06

(57) ABSTRACT

There is provided a control device configured to be connected to a robot that picks an object and a camera that captures an image of the object, the control device including: a first acquisition unit configured to acquire the image in which the object is captured; a recording unit including a database in which a plurality of picking positions of the object and a success or failure result of picking of the object are accumulated for each picking position of the object; a calculation unit configured to calculate the picking position of the object based on the image and the database; and a control unit configured to output a control parameter based on the calculated picking position to the robot and cause the robot to execute the picking.

### CROSS-REFERENCE TO RELATED APPLICATIONS

This application is based on and claims priority under 35 USC 119 from Japanese Patent Application No. 2025-076921 filed on May 2, 2025, the contents of which are incorporated herein by reference.

### TECHNICAL FIELD

The present disclosure relates to a control device, a control method for a robot system, and a robot control system.

### BACKGROUND ART

JP2013-184279A discloses an information processing device that obtains a position and posture of at least one target object from a result of measuring a set of target objects using a first sensor, controls a robot having a gripping unit to cause the gripping unit to grip one target object among the at least one target object as a gripping target object, determines whether the gripping unit has succeeded in gripping the gripping target object from a result of measurement performed after control by a second sensor for measuring the target object gripped by the gripping unit, and selects one target object having an interaction with the gripping target object among the at least one target object when the gripping unit has failed in gripping the gripping target object. The information processing device controls the robot to cause the gripping unit to grip the selected target object.

### SUMMARY OF INVENTION

The present disclosure provides a control device, a control method for a robot system, and a robot control system that automate picking of an object using a robot.

According to an illustrative aspect of the present disclosure, a control device configured to be connected to a robot that picks an object and a camera that captures an image of the object, includes: a first acquisition unit configured to acquire the image in which the object is captured; a recording unit including a database in which a plurality of picking positions of the object and a success or failure result of picking of the object are accumulated for each picking position of the object; a calculation unit configured to calculate the picking position of the object based on the image and the database; and a control unit configured to output a control parameter based on the calculated picking position to the robot and cause the robot to execute the picking.

According to another illustrative aspect of the present disclosure, a control method for a robot system executed by a computer that controls a robot that picks an object and a camera that captures an image of the object, includes: acquiring the image in which the object is captured; storing a database in which a plurality of picking positions of the object and a success or failure result of picking of the object are accumulated for each picking position of the object; calculating the picking position of the object based on the image and the database; and outputting a control parameter based on the calculated picking position to the robot and causing the robot to execute the picking.

According to another illustrative aspect of the present disclosure, a robot control system includes: a robot configured to pick an object; a camera configured to capture an image of the object; and a control device communicable between the robot and the camera, and configured to control the robot and the camera. The control device is configured to: acquire the image in which the object is captured; store a database in which a plurality of picking positions of the object and a success or failure result of picking of the object are accumulated for each picking position of the object; calculate the picking position of the object based on the image and the database; and output a control parameter based on the calculated picking position to the robot and cause the robot to execute the picking. The robot is configured to perform the picking of the object based on the control parameter.

According to the present disclosure, it is possible to automate picking of an object using a robot.

### BRIEF DESCRIPTION OF DRAWINGS

FIG. 1 is a diagram illustrating an overall configuration example of a picking system according to an embodiment;

FIG. 2 is a diagram illustrating advance registration of a product and a method for selecting an end effector;

FIG. 3 is a diagram illustrating a learning method for a control device during learning;

FIG. 4 is a diagram illustrating an example of a picking success probability map;

FIG. 5 is a diagram illustrating a picking operation improvement method of the control device during an operation; and

FIG. 6 is a diagram illustrating a picking operation improvement method and an additional learning method of the control device during an operation.

### DESCRIPTION OF EMBODIMENTS

### Background of Present Disclosure

A warehouse for receiving, storing, packing, shipping, or the like of goods is required to automate work using a robot or the like in order to reduce a manual work load. With an increase in the number of goods in recent years, further improvement in efficiency related to a series of works is required. In such a warehouse, since articles having various shapes or attributes (hereinafter, also referred to as "products" or "objects") are handled, it is necessary for a person or a robot to share works in consideration of characteristics of the products. As one of such works, there is a picking work of transferring a product from an accommodation unit (hereinafter, referred to as a "storage bin") in which the product is accommodated to an accommodation unit (hereinafter, referred to as a "shipping bin") that accommodates one or a plurality of products to be shipped based on a shipping instruction.

In introduction of a robot that executes such picking work, a worker needs to select an end effector for executing the picking work and determine a parameter for causing the robot to execute the picking work. Therefore, the selection of the end effector required the workers to have the expertise to introduce the robot to the site, and the expertise to continuously improve the parameter when determining the parameter of the robot. In addition, selection of the end effector and determination of the parameter of the robot require various information. However, a customer may not have such information, and it is difficult to select the end effector.

Therefore, in the following embodiment, examples of a control device, a control method for a robot system, and a robot control system that automate picking of an object using a robot will be described.

Hereinafter, the embodiment specifically disclosing configurations and operations of a control device, a control method for a robot system, and a robot control system according to the present disclosure will be described in detail with reference to the drawings as appropriate. However, unnecessarily detailed description may be omitted. For example, detailed description of well-known matters and redundant description of substantially the same configuration may be omitted. This is to avoid unnecessary redundancy of the following descriptions and to facilitate understanding of those skilled in the art. The accompanying drawings and the following description are provided for those skilled in the art to fully understand the present disclosure, and are not intended to limit the subject matters described in the claims.

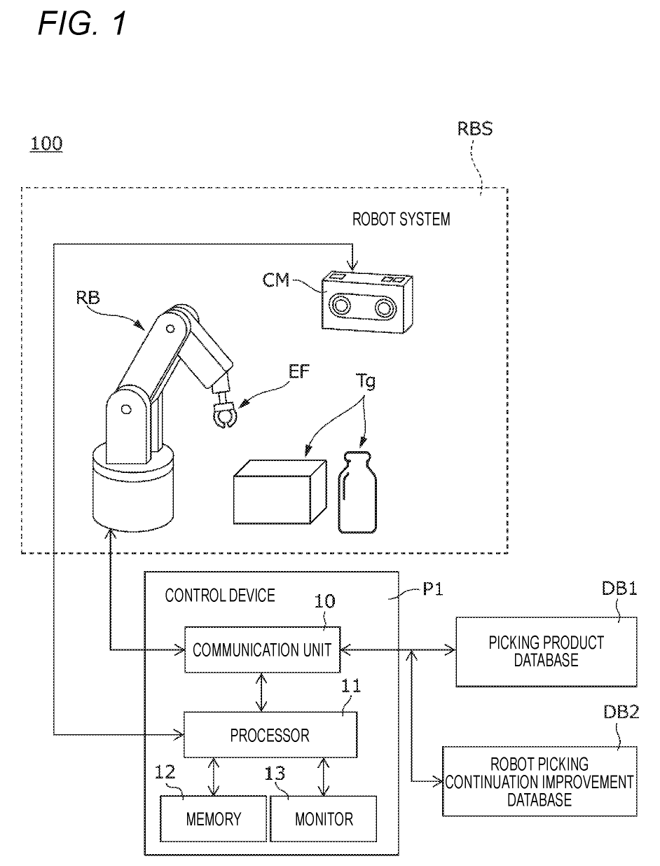

First, a picking system 100 according to the embodiment will be described with reference to FIG. 1. FIG. 1 is a diagram illustrating an overall configuration example of the picking system 100 according to the embodiment. The picking system 100 illustrated in FIG. 1 is an example and is not limited thereto. For example, the number of picking robots RB controlled by one control device P1 may be multiple. In addition, although the picking robot RB illustrated in FIG. 1 illustrates an example in which only a gripper hand is provided as an end effector EF, the picking robot RB may actually include a gripper hand and a suction pad as a plurality of end effectors EF capable of picking a product Tg by different methods, or may include any selected end effector EF.

The picking system 100 is a system in which the picking robot RB grips the product Tg as a picking target and transports the product Tg to a predetermined arrangement position. The picking system 100 includes a robot system RBS, a control device P1, a picking product database DB1, and a robot picking continuous improvement database DB2. The picking system 100 illustrated in FIG. 1 is an example and is not limited thereto.

The robot system RBS is controlled by the control device P1 to realize recognition of a gripping position of the product Tg by a 3D camera CM, gripping of the product Tg by the end effector EF, transporting of the gripped product Tg, and arrangement of the product Tg at the predetermined arrangement position. The robot system RBS includes the picking robot RB and the 3D camera CM. The robot system RBS illustrated in FIG. 1 is an example, and is not limited thereto.

The picking robot RB is an articulated robot including at least one end effector EF. The picking robot RB is data-communicably connected to the control device P1 and receives a control by the control device P1. The picking robot RB executes each of gripping, transporting, and arrangement of the product Tg and realizes a picking work of the product Tg. In the present disclosure, the picking robot RB is realized by the suction pad that sucks and grips a surface of the product Tg or the gripper hand that grabs and grips the product Tg as an example of the end effector EF.

The 3D camera CM includes at least a lens (not illustrated) and an image sensor (not illustrated). The image sensor is, for example, a solid-state imaging element such as a charged-coupled device (hereinafter referred to as a "CCD") or a complementary metal oxide semiconductor (hereinafter referred to as a "CMOS"), and converts an optical image formed on an imaging surface into an electric signal. The 3D camera CM executes imaging according to a control instruction to start imaging transmitted from the control device P1.

The 3D camera CM is communicably connected to the control device P1. The 3D camera CM captures an image of the product Tg as a picking target from a plurality of different imaging positions (viewpoints), and transmits a plurality of RGB images and a plurality of depth images of the product Tg to the control device P1. The 3D camera CM during a picking work captures an image of an area including a gripping area where the product Tg is gripped and an arrangement area where the gripped product Tg is arranged, and transmits the captured image (specifically, the plurality of RGB images and the plurality of depth images) to the control device P1.

The control device P1 is implemented by, for example, a personal computer (hereinafter, referred to as a "PC"), a notebook PC, or a tablet terminal. The control device P1 executes selection of the end effector EF of the picking robot RB, determination of a recognition parameter for realizing recognition of the product Tg by the 3D camera CM and a control parameter for causing the picking robot RB to grip the product Tg, and continuous improvement of the recognition parameter and the control parameter based on record data of the picking work of the product Tg executed by the robot system RBS. The control device P1 is connected to the picking robot RB, the 3D camera CM, the picking product database DB1, and the robot picking continuous improvement database DB2 so as to be able to perform data communication. The control device P1 includes a communication unit 10, a processor 11, and a memory 12.

The communication unit 10 is connected to the picking robot RB, the 3D camera CM, the picking product database DB1, and the robot picking continuous improvement database DB2 so as to be able to perform wired communication or wireless communication, and executes transmission and reception of data. The wireless communication here is, for example, short-range wireless communication such as Bluetooth (registered trademark) or NFC (registered trademark), or communication via a wireless local area network (LAN) such as Wi-Fi (registered trademark).

The communication unit 10 outputs various data transmitted from the picking robot RB, the 3D camera CM, the picking product database DB1, and the robot picking continuous improvement database DB2 to the processor 11. The communication unit 10 transmits various data output from the processor 11 to the picking robot RB, the 3D camera CM, the picking product database DB1, or the robot picking continuous improvement database DB2.

The processor 11 is implemented by using, for example, a central processing unit (hereinafter, referred to as a "CPU") or a field programmable gate array (hereinafter, referred to as a "FPGA"), and executes various kinds of processing and controls in cooperation with the memory 12. Specifically, the processor 11 implements each function by referring to a program and data stored in the memory 12 and executing the program.

The memory 12 includes, for example, a random access memory (hereinafter, referred to as a "RAM") as a work memory used when each processing of the processor 11 is performed, and a read only memory (hereinafter, referred to as a "ROM") storing a program and data defining each operation of the processor 11. The RAM temporarily stores data or information generated or acquired by the processor 11. The program that defines the operation of the processor 11 is written in the ROM.

The monitor 13 is implemented by using, for example, a liquid crystal display (LCD) or an organic electroluminescence (EL). The monitor 13 displays various data (information) output from the processor 11.

The picking product database DB1 is realized by a cloud server or an on-premise server. The picking product database DB1 is connected to the control device P1 so as to be able to perform data communication. The picking product database DB1 stores, for each product Tg, information on the product Tg as the picking target and information on the end effector EF used for picking the product Tg.

The information on the product Tg here is, for example, a product image of the product Tg, point cloud data of the product Tg, a product size of the product Tg, or a product description of the product Tg. The information on the end effector EF is information on the end effector EF recommended to be used in the picking work of the product Tg by the control device P1, and stores, for example, the gripping position and the size of the end effector EF for each end effector EF.

The robot picking continuous improvement database DB2 is realized by a cloud server or an on-premise server. The robot picking continuous improvement database DB2 is connected to the control device P1 so as to be able to perform data communication. The robot picking continuous improvement database DB2 stores information on the product Tg as the picking target and various types of information used for continuous improvement of the picking operation of the product Tg.

The information on the product Tg as the picking target here is, for example, the product image of the product Tg, the point cloud data of the product Tg, the product size of the product Tg, or the product description of the product Tg. The various types of information used for continuous improvement of the picking operation of the product Tg include, for example, the picking position and a posture of the product Tg, the picking result, a feedback value of the end effector EF, and a picking success probability map.

Here, in the present disclosure, an example is illustrated in which the control device P1, the picking product database DB1, and the robot picking continuous improvement database DB2 are configured as separate bodies, but the present disclosure is not limited thereto. The control device P1, the picking product database DB1, and the robot picking continuous improvement database DB2 may be integrally configured. The control device P1 may be realized by a cloud server or an on-premise server, or may be realized by a cloud server or an on-premise server configured integrally with the picking product database DB1 and the robot picking continuous improvement database DB2.

### Method for Selecting End Effector

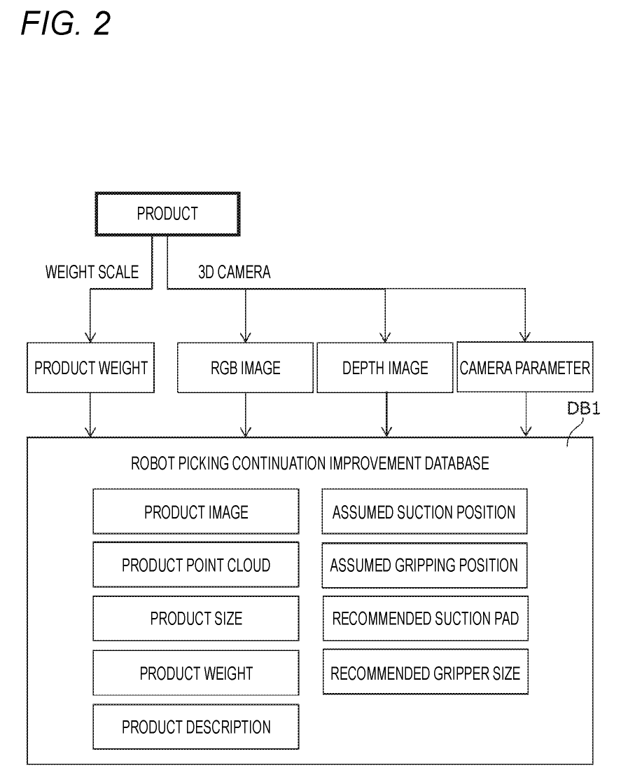

Next, a method for selecting the end effector EF will be described with reference to FIG. 2. FIG. 2 is a diagram illustrating advance registration of a product and the method for selecting the end effector EF.

In order to select the end effector EF, the control device P1 receives registration of weight of the product Tg (product weight), the plurality of RGB images and the plurality of depth images of the product Tg, and camera parameters of the 3D camera CM that captures the plurality of RGB images and the plurality of depth images as the information on the product Tg. The information or data to be registered is not limited to the information or data described above.

The 3D camera CM captures an image of the product Tg from a plurality of different viewpoints (imaging positions). The 3D camera CM associates the plurality of RGB images and the plurality of depth images of the captured product Tg with the camera parameters when the RGB images and the depth images are captured, and outputs them to the control device P1. The camera parameters here include an external parameter indicating a position and posture of the 3D camera CM with respect to a world coordinate system, and an internal parameter indicating distortion of a lens of the 3D camera CM. The 3D camera CM that captures the image of the product Tg may be a 3D camera different from the 3D camera CM included in the robot system RBS.

A weight scale (not illustrated) measures the weight of the product Tg and outputs the weight to the control device P1. The weight of the product Tg may be measured by the worker and input to the control device P1 via a user interface such as a keyboard or a touch panel.

The control device P1 acquires the plurality of RGB images and the plurality of depth images of the product Tg captured by the 3D camera CM from a plurality of different viewpoints, and the camera parameters of the 3D camera CM. The control device P1 acquires the weight of the product Tg measured by the weight scale.

The control device P1 generates color point cloud data indicating a three-dimensional shape of the product Tg based on the acquired plurality of RGB images and the acquired plurality of depth images. The control device P1 estimates the size of the product Tg in a three-dimensional space based on the plurality of RGB images and the plurality of depth images.

The control device P1 analyzes the texture (that is, characteristics such as material and unevenness) of the surface of the product Tg by performing image analysis on the plurality of RGB images. The control device P1 generates information on the product description in which an analysis result of the surface of the product Tg is converted into text. The control device P1 may analyze the texture (characteristics) of the surface of the product Tg using not only the plurality of RGB images but also the plurality of depth images, the color point cloud data, or the like, or may receive an input operation of text data indicating the texture (the characteristics) of the surface of the product Tg by the worker.

Based on at least one RGB image (product image), the color point cloud data (product point cloud), the size (product size) of the product Tg, the weight (product weight) of the product Tg, and the product description, the control device P1 estimates the gripping position (suction position) of the product Tg when each of the plurality of end effectors EF usable by the picking robot RB is used, and selects the size of the end effector EF used to grip the product Tg. Hereinafter, processing of estimating the gripping position (the suction position) of the product Tg and Tg processing of selecting the size of the end effector EF will be specifically described.

For example, when the suction pad is used as the end effector EF, the control device P1 estimates a position where suction can be performed by the suction pad and a size of a suction surface (hereinafter, referred to as a "suction surface size") where the suction pad can perform suction at this position based on the color point cloud data (that is, the three-dimensional shape of the product Tg), the size of the product Tg (the product size), the product description, a weight of the product Tg (product weight), or the like. The control device P1 selects a suction position (hereinafter, referred to as an "assumed suction position") more suitable for gripping, transporting, and arrangement of the product Tg by the suction pad among the estimated suction positions.

The control device P1 estimates the size of the suction pad recommended to be used in gripping (sucking) the product Tg (hereinafter referred to as "recommended suction pad size") based on the selected assumed suction position and suction surface size and the product weight. Here, the assumed suction position is six-dimensional information, and includes coordinate information (three-dimensional) of the suction position at which the suction pad sucks the product Tg and suction posture information (three-dimensional) at which the suction pad sucks the product Tg.

For example, when the gripper hand is used as the end effector EF, the control device P1 estimates the gripping position that is grippable by the gripper hand based on the color point cloud data (that is, the three-dimensional shape of the product Tg), the size of the product Tg (product size), the product description, the product weight, or the like. The control device P1 estimates the gripping position (hereinafter, referred to as an "assumed gripping position") more suitable for gripping, transporting, and arrangement of the product Tg by the gripper hand among the estimated gripping positions.

The control device P1 estimates the size of the gripper hand used for gripping the product Tg based on the estimated assumed gripping position, the size of the product Tg corresponding to the gripping position, and the product weight. The control device P1 estimates a size of a recommended gripper hand (hereinafter, referred to as a "recommended gripper size") recommended to be used for gripping the product Tg based on the estimated assumed gripping position and the product weight. Here, the assumed gripping position here is six-dimensional information, and includes coordinate information (three-dimensional) of the gripping position at which the gripper hand grips the product Tg and gripping posture information (three-dimensional) at which the gripper hand grips the product Tg.

The control device P1 may determine whether the product Tg is grippable by each end effector EF based on the product description (that is, the state of the surface of the product Tg) or the product weight. The control device P1 may estimate the suction surface size of the product Tg corresponding to the suction position or the size of the product Tg corresponding to the gripping position, and determine whether the product Tg can be gripped by each end effector EF based on the estimated suction surface size or the size of the product Tg and the product description or the product weight. In such a case, the control device P1 may estimate the assumed suction position or the assumed gripping position corresponding to the end effector EF determined to be grippable, and the recommended suction pad size or the recommended gripper size.

The control device P1 may execute selection of any end effector EF recommended to be used, evaluation of a recommendation degree recommended to be used, or the like based on the estimated assumed suction position or assumed gripping position and the recommended suction pad size or recommended gripper size.

The control device P1 refers to the picking product database DB1 or the robot picking continuous improvement database DB2 to acquire information on each of the plurality of products for which the picking work has been executed in the past and information on the end effector EF used or selected in the picking work of these products. The control device P1 may select any end effector EF recommended to be used, evaluate the recommendation degree of the end effector EF, or the like based on the similarity between the information on each of the plurality of past products and the information on the product Tg that is the target of the picking work this time, past records of the end effector EF used or selected in the picking work of the product, or the like.

The control device P1 outputs the plurality of acquired RGB images and the plurality of acquired depth images, the product weight, the point cloud data, the product size, the product description, the gripping position for each end effector EF, and the size of the end effector EF to the monitor 13 or stores them in the picking product database DB1 in association with each other for each product Tg.

Accordingly, the control device P1 can estimate each of the gripping (suction) position and the gripping (suction) posture for each end effector EF more suitable for the picking work (particularly, gripping) of the product Tg with higher accuracy based on the three-dimensional shape, the size, the weight, the texture (characteristics) of the surface of the product Tg, the past picking records of the product Tg, or the like. The control device P1 can realize selection of the end effector EF more suitable for the picking work (particularly, gripping) of the product Tg based on the three-dimensional shape, the size, the weight, the texture (characteristics) of the surface, the past picking record of the product Tg, or the like of the product Tg.

When there are a plurality of candidates for the end effector EF usable for the picking work of the product Tg, the control device P1 may receive a selection operation of the end effector EF to be used by the worker operation or may select the end effector EF according to the recommendation degree. Thus, the control device P1 can assist the worker in selecting the end effector EF.

When information on each of a plurality of products for which the picking work has been executed in the past and information on the end effector EF used or selected in the picking work of the products are acquired, the control device P1 may output these pieces of information to the monitor 13. Accordingly, when the control device P1 receives the selection operation of any end effector EF by the worker, the control device P1 can support the selection operation of the end effector EF by visualizing the data of the end effector EF selected in the past.

### Method for Generating Picking Success Probability Map During Learning

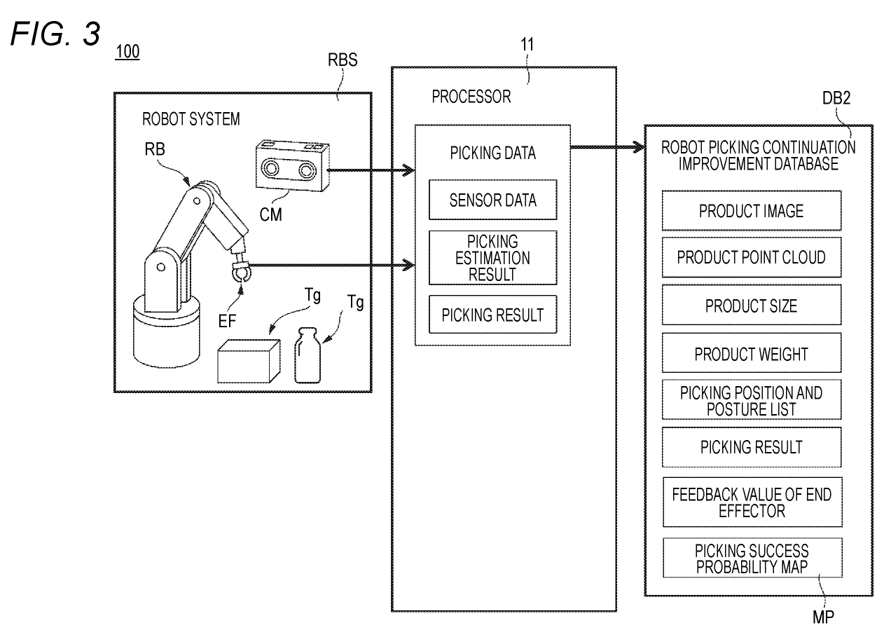

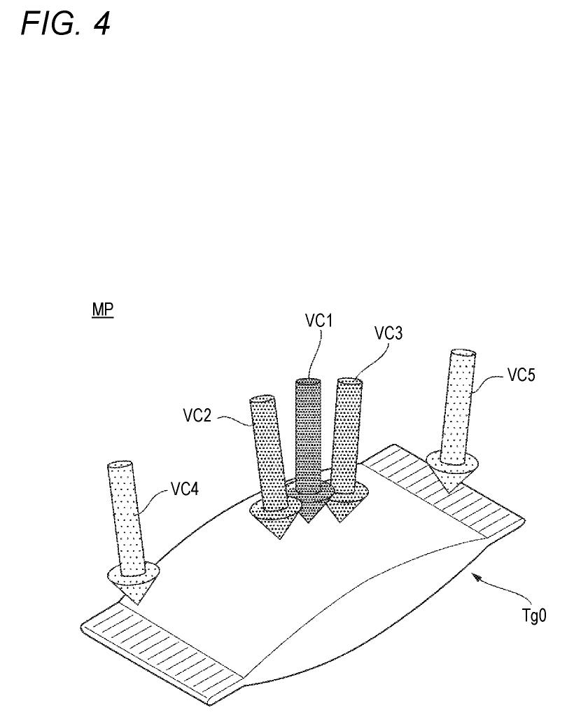

Next, a method for generating the picking success probability map will be described with reference to FIGS. 3 and 4. FIG. 3 is a diagram illustrating a learning method for the control device during learning. FIG. 4 is a diagram illustrating an example of a picking success probability map MP.

First, various data stored in the robot picking continuous improvement database DB2 will be described. The robot picking continuous improvement database DB2 stores the product image of the product Tg, the point cloud data of the product Tg, the product size of the product Tg, the Tg product description of the product Tg, the picking position and posture of the product Tg, the picking Tg result, the feedback value of the end effector EF, the picking success probability map, and the like.

The product image is image data registered at the time of product registration and is an appearance image (RGB image) of the product Tg registered in the picking product database DB1. The product point cloud is data registered at the time of product registration, and color point cloud data (3D data) indicating the three-dimensional shape of the product Tg registered in the picking product database DB1. The product size is data registered at the time of product registration and is information on the size of the product Tg registered in the picking product database DB1. The product weight is data registered at the time of product registration and is the weight of the product Tg registered in the picking product database DB1.

A picking position and posture list stores coordinates of the gripping position (suction position) at which the product Tg is gripped (sucked) by the end effector EF and a posture at which the product Tg is gripped (sucked). The picking position and posture list before the start of operation is estimated at the time of product registration, and the assumed gripping position or the assumed suction position of the end effector EF used for the picking work is stored as initial values of the gripping position and the gripping posture or the suction position and the suction posture of the product Tg. The picking position and posture list after the start of operation stores the updated latest suction position and suction posture or gripping position and gripping posture of the end effector EF.

The picking result is stored and accumulated by associating the gripping position and the gripping posture with information on success or failure of each of gripping, transporting, and arrangement of the product Tg gripped at the gripping position and the gripping posture.

The feedback value of the end effector EF is a feedback value of the end effector EF that has performed a gripping (suction) operation of the product Tg. Specifically, when the end effector EF is a suction pad, the processor 11 acquires information on a vacuum pressure during suction as the feedback value, and when the end effector EF is a gripper hand, the processor 11 acquires information on a torque during gripping as the feedback value.

The picking success probability map MP is map data in which at least one vector VC1, VC2, VC3, VC4, and VC5 indicating the gripping (suction) position and the gripping (suction) posture and a success or failure probability of the picking work of the product Tg gripped at the gripping (suction) position and the gripping (suction) posture are superimposed on image data Tg0 of the product Tg. The picking success probability map MP may be map data in which at least one vector is superimposed on the point cloud data of the product Tg.

In each of the vectors VC1 to VC5, a position of a surface of the product Tg indicated by a tip of an arrow indicates the gripping (suction) position (three-dimensional) of the product Tg, and a direction of an arrow with respect to the product Tg indicates the gripping (suction) posture (three-dimensional) of the product Tg. FurTger, the vectors VC1 to VC5 visualize the success or failure probability of the picking work of the product Tg gripTgd at the corresponding gripping position and gripping posture by a difference in color. For example, the vectors VC1 to VC5 are displayed in blue to red, and a color closer to blue indicates a higher success probability of the picking work, and a color closer to red indicates a lower success probability of the picking work.

First, the processor 11 of the control device P1 determines the recognition parameter for recognizing the gripping position of the product Tg by the 3D camera CM and the control parameter for gripping the product Tg by the end effector EF and executing the picking operation based on the information on the product Tg acquired in the method for selecting the end effector EF, the recommended suction pad size and the recommended gripper size of the end effector EF provided in the picking robot RB, and the assumed suction position or the assumed gripping position corresponding to the end effector EF. The processor 11 generates the determined recognition parameter and a control command for executing a recognition control based on the recognition parameter, and transmits the recognition parameter and the control command to the 3D camera CM. The processor 11 generates the determined control parameter and the control command for executing the picking operation based on the control parameter, and transmits the control parameter and the control command to the picking robot RB.

The processor 11 acquires each of the plurality of RGB images and each of the plurality of depth images captured by the 3D camera CM as an example of sensor data. The processor 11 collates the plurality of acquired RGB images and the plurality of acquired depth images of the product Tg with the plurality of RGB images and the plurality of depth images of the product Tg captured at the time of product registration, respectively. The processor 11 calculates a difference between the recognition position of the product Tg to be recognized by the recognition parameter and the recognition position of the product Tg recognized by the 3D camera CM during an operation by the collation.

The processor 11 acquires the feedback value transmitted from the end effector EF as an example of a picking estimation result. The processor 11 estimates the gripping position and the gripping posture of the product Tg based on the feedback value of the end effector EF.

The processor 11 determines whether the gripping, transporting, and arrangement of the product Tg are each successful based on the collation result of the captured image of the product Tg and the estimated gripping position and gripping posture of the product Tg.

The processor 11 generates a picking result in which the acquired information on the gripping position and the gripping posture of the product Tg is associated with information on each of success or failure of gripping, success or failure of transporting, and success or failure of arrangement of the product Tg, and stores and accumulates the picking result in the robot picking continuous improvement database DB2.

Based on the picking success probability map MP stored in the robot picking continuous improvement database DB2, the processor 11 generates a new vector corresponding to the gripping position and the gripping posture, or recalculates the success or failure probability of a series of picking works corresponding to the gripping position and the gripping posture. When the new vector is generated, the processor 11 generates the picking success probability map MP in which the generated vector is further superimposed on the image data Tg0 of the product Tg. On the other hand, when recalculating the success or failure probability of the picking work, the processor 11 generates the picking success probability map MP in which a color of the corresponding vector is changed.

As described above, by generating the picking success probability map MP, the control device P1 in the present disclosure can realize the generation of the control parameter and the recognition parameter with which the picking success probability becomes higher during the operation.

### Picking Operation Improvement Method During Operation

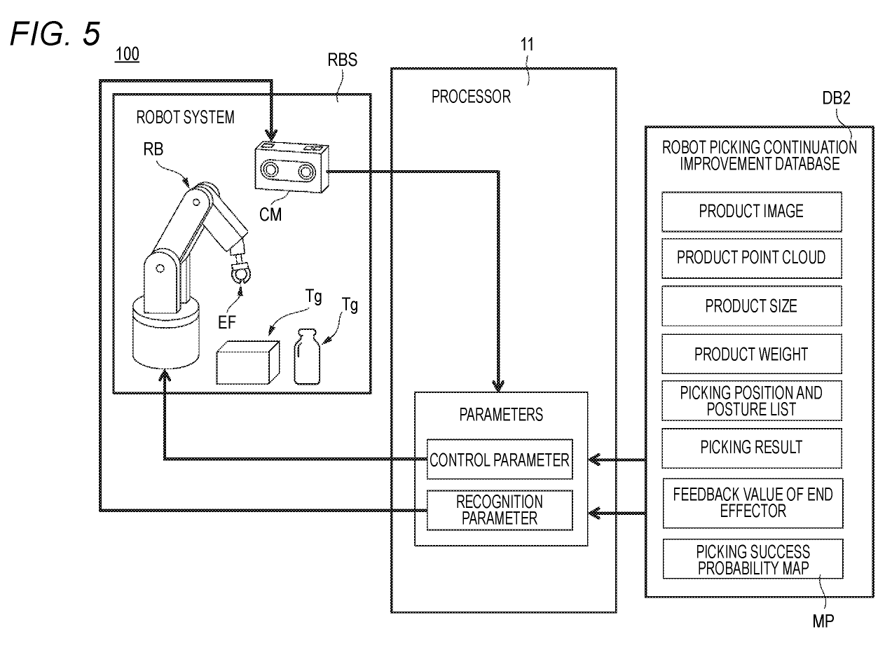

Next, a picking operation improvement method will be described with reference to FIG. 5. FIG. 5 is a diagram illustrating the picking operation improvement method of the control device P1 during the operation.

The 3D camera CM captures the image of the product Tg. The processor 11 acquires each of the plurality of RGB images and each of the plurality of depth images captured by the 3D camera CM. The processor 11 performs image analysis on each of the plurality of RGB images and each of the plurality of depth images of the acquired product Tg and acquires an arrangement state of the product Tg as the picking target. The arrangement state of the product Tg here is, for example, a three-dimensional position and a three-dimensional posture of the product Tg, or a positional relationship and an overlapping degree between the product Tg and an obstacle (for example, another product, a collection bin, or the like). The position, posture, and the like (arrangement state) of the product Tg may be acquired based on a difference obtained by collating the product Tg appearing in the product image or the product point cloud (3D data) registered at the time of product registration with the product Tg appearing in the plurality of RGB images and the plurality of depth images captured by the 3D camera CM. The processor 11 executes estimation (selection) of the end effector EF recommended to be used in the picking work of the product Tg based on the arrangement state of the product Tg.

Specifically, the processor 11 estimates the recommended suction pad size and the assumed suction position (six directions) when the suction pad is used as the end effector EF based on the suction surface size of the suction pad, the product weight of the product Tg, the picking success probability map MP, suction position candidates of the product Tg indicated by the arrangement state of the product Tg, and the suction surface size (area) that can be sucked by the suction pad at each suction position candidate. The processor 11 estimates the recommended gripper size and the assumed gripper position (six directions) when the gripper is used as the end effector EF based on the gripper size of the gripper, the product weight of the product Tg, the picking success probability map MP, grip position candidates of the gripper indicated by the arrangement state of the product Tg, and the size of the gripper surface that can be gripped by the gripper at each grip position candidate.

When the arrangement state of the product Tg is a situation in which the other product overlaps the product Tg and the picking at the picking position where the success probability is high is not possible, the processor 11 may select a position where the other product does not overlap the product and the picking by the end effector EF is possible as the picking position.

The processor 11 visualizes the estimation result to the worker and receives a designation operation of the end effector used for the picking work. The processor 11 may automatically select an end effector estimated to have a higher picking success probability of the product Tg among the plurality of end effectors EF based on the estimation result.

The processor 11 determines the recognition parameter and the control parameter for increasing the picking success probability based on the arrangement state of the product Tg as the picking target, the product weight, and the picking position (that is, the assumed suction position or the assumed gripping position) by the selected end effector EF. Specifically, the processor 11 executes search processing using a rule base for obtaining the recognition parameter and the control parameter for increasing the picking success probability. The processor 11 updates the currently set recognition parameter to the determined recognition parameter and transmits the recognition parameter to the 3D camera CM. The processor 11 updates the currently set control parameter to the determined control parameter and transmits the updated control parameter to the picking robot RB.

The processor 11 changes the control parameter (for example, a control speed) of the end effector EF based on the product weight, the picking result, the feedback value of the end effector EF, or the like stored in the robot picking continuous improvement database DB2. The processor 11 updates the currently set control parameter to the determined control parameter and transmits the updated control parameter to the picking robot RB.

As described above, the control device P1 in the present disclosure can generate the recognition parameter and the control parameter for further increasing the picking success probability based on the generated picking success probability map MP. In addition, the control device P1 in the present disclosure can improve the picking success probability for the product Tg in various arrangement states by selecting the end effector EF and generating the recognition parameter and the control parameter in consideration of an actual arrangement state of the product Tg without being limited to the picking position and the picking posture where the success probability indicated by the generated picking success probability map MP is high.

### Picking Operation Improvement Method and Additional Learning Method During Operation

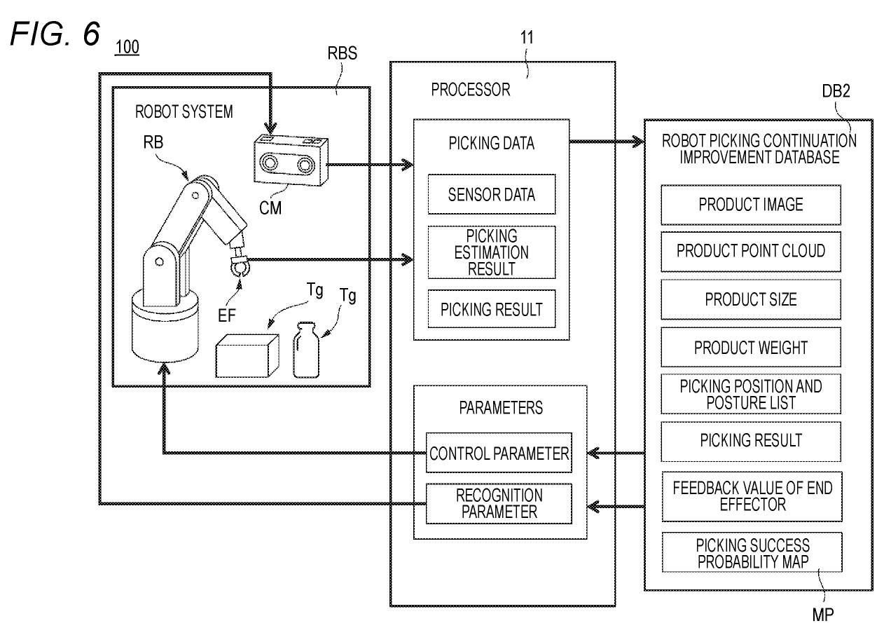

Next, the picking operation improvement method and an additional learning method will be described with reference to FIG. 6. FIG. 6 is a diagram illustrating the picking operation improvement method and the additional learning method of the control device P1 during the operation.

When the picking operation improvement based on the arrangement state of the product Tg and the picking success probability map MP and the additional learning method of the picking success probability map MP are executed in parallel, the processor 11 acquires the picking result based on the recognition parameter and the control parameter generated in the picking operation improvement and executes the additional learning of the picking success probability map MP based on the acquired picking result. The processor 11 generates the recognition parameter and the control parameter for picking a next picking target or the product Tg for which the picking has failed based on the picking success probability map MP additionally learned.

The processor 11 generates the recognition parameter and the control parameter for picking the product Tg by the operation illustrated in FIG. 5, and transmits the recognition parameter and the control parameter to each of the 3D camera CM and the picking robot RB.

The robot system RBS executes the recognition of the product Tg by the 3D camera CM and the picking work for the product Tg by the picking robot RB. The robot system RBS transmits each of the plurality of RGB images and each of the plurality of depth images captured by the 3D camera CM to the control device P1. Further, the robot system RBS transmits the feedback value of the end effector EF obtained during the picking work to the control device P1.

The processor 11 acquires each of the plurality of RGB images and each of the plurality of depth images captured by the 3D camera CM. The processor 11 executes the operation illustrated in FIG. 3 and calculates the difference between the recognition position of the product Tg to be recognized by the recognition parameter and the recognition position of the product Tg recognized by the 3D camera CM during the operation. The processor 11 acquires the feedback value transmitted from the end effector EF. The processor 11 executes the operation illustrated in FIG. 3 and estimates the gripping position and the gripping posture of the product Tg.

Based on the collation result of the captured image of the product Tg and the estimated gripping position and gripping posture of the product Tg, the processor 11 acquires the information on the acquired gripping position and gripping posture of the product Tg and the information on success or failure of gripping, success or failure of transporting, and success or failure of arrangement of the product Tg. The processor 11 generates the picking result associated with the above, and stores and accumulates the picking result in the robot picking continuous improvement database DB2.

The processor 11 additionally learns the picking success probability map MP based on the picking result. The processor 11 generates the new vector corresponding to the gripping position and the gripping posture indicated by the picking result, or recalculates the success or failure probability of a series of picking works corresponding to the gripping position and the gripping posture. When the new vector is generated, the processor 11 generates the picking success probability map MP in which the generated vector is further superimposed on the image data Tg0 of the product Tg. On the other hand, when recalculating the success or failure probability of the picking work, the processor 11 generates the picking success probability map MP in which a color of the corresponding vector is changed.

When the additional learning is executed using the picking result, the processor 11 may determine, as the picking position of the product Tg, the picking position that is possible for picking by the end effector EF and has few or no picking records in the picking success probability map MP even in a case where the product Tg can be gripped with the picking position candidate indicated by the picking success probability map MP.

Similarly, when the picking fails based on the picking result, the processor 11 may determine, as the picking position of the product Tg, a picking position that is possible for picking by the end effector EF and has few or no picking records in the picking success probability map MP.

As described above, the control device P1 in the present disclosure can realize improvement of the picking operation and additional learning of the picking success probability map MP. Accordingly, the control device P1 can execute the additional learning of the picking success probability map MP by collecting picking data during the operation and tuning of the recognition parameter and the control parameter based on the picking success probability map MP additionally learned at regular intervals (for example, once a day or once a week). That is, the control device P1 can continue to automatically improve a success rate of the picking work of the product Tg by the picking robot RB. The tuning of the recognition parameter and the control parameter may be executed at any timing requested by the worker, or may be periodically executed as described above.

### Appendix

The following techniques are disclosed based on the above description of the embodiment.

### Technique 1

A control device P1 connected to a robot (the picking robot RB) that picks an object (the product Tg) and a camera (the 3D camera CM) that captures an image of the object (the product Tg), includes:
a first acquisition unit (the communication unit 10) configured to acquire the image (the plurality of RGB images and the plurality of depth images) in which the object (the product Tg) is captured;
a recording unit (the processor 11) including a database (the robot picking continuous improvement database DB2) in which a plurality of picking positions of the object (the product Tg) and a success or failure result of picking of the object (the product Tg) are accumulated for each picking position of the object (the product Tg);
a calculation unit (the processor 11) configured to calculate the picking position of the object (the product Tg) based on the image and the database (the robot picking continuous improvement database DB2); and
a control unit (the processor 11) configured to output a control parameter based on the calculated picking position to the robot (the picking robot RB) and cause the robot (the picking robot RB) to execute the picking.

Accordingly, the control device P1 can generate a control parameter for further increasing the picking success probability based on the picking success probability map MP of the robot picking continuous improvement database DB2.

### Technique 2

In the control device P1 according to Technique 1,
the calculation unit (the processor 11) calculates the picking position of the object (the product Tg) based on an arrangement state of the object (the product Tg) appearing in the image and the database (the robot picking continuous improvement database DB2).

Accordingly, the control device P1 can improve the picking success probability for the product Tg in various arrangement states by generating the control parameter in consideration of the actual arrangement state of the product Tg without being limited to the picking position where the success probability indicated by the generated picking success probability map MP is high.

### Technique 3

In the control device P1 according to Technique 1 or Technique 2,
the database (the robot picking continuous improvement database DB2) accumulates the plurality of picking positions, a plurality of picking postures of the object (the product Tg), and the success or failure result of the picking of the object (the product Tg) for each picking position of the object (the product Tg), and
the calculation unit (the processor 11) calculates the picking position of the object (the product Tg) andTghe gripping posture of the object (the product Tg) basTg on the image and the database (the robot picking continuous improvement database DB2).

Accordingly, the control device P1 can improve the picking success probability for the product Tg in various arrangement states by generating the control parameter based on the picking position and the picking posture in consideration of the actual arrangement state of the product Tg without being limited to the picking position and the picking posture where the success probability indicated by the generated picking success probability map MP is high.

### Technique 4

In the control device P1 according to any one of Technique 1 to Technique 3,
the robot (the picking robot RB) includes a plurality of different end effectors, and
the calculation unit (the processor 11) determines an end effector that picks the object (the product Tg) among the plurality of end effectors based on the image and the database (the robot picking continuous improvement database DB2).

Accordingly, the control device P1 can improve the picking success probability for the product Tg in various arrangement states by generating the control parameter based on the picking position and the picking posture in consideration of the actual arrangement state of the product Tg without being limited to the picking position and the picking posture where the success probability indicated by the generated picking success probability map MP is high.

### Technique 5

In the control device P1 according to any one of Technique 1 to Technique 4,
the database (the robot picking continuous improvement database DB2) stores a registered image of the object (the product Tg) registered in advance, and
the calculation unit (the processor 11) determines the picking position of the object (the product Tg) based on a difference between the image and the object (the product Tg) appearing in the registered image.

Accordingly, even when recognition accuracy of the 3D camera CM is low, the control device P1 can more easily specify the picking position of the product Tg by collating the product appearing in the registered image with the product appearing in the captured image captured in real time. Therefore, the control device P1 can realize the calculation of the picking position and the generation of the control parameter corresponding to the actual arrangement state of the product Tg, and can improve the picking success probability of the product Tg.

### Technique 6

In the control device P1 according to any one of Technique 1 to Technique 5,
the control unit (the processor 11) outputs an imaging parameter based on the picking position to the camera (the 3D camera CM) and causes the camera (the 3D camera CM) to capture an image of the picking position.

Accordingly, even when the recognition accuracy of the 3D camera CM is low, the control device P1 can more easily specify the picking position of the product Tg by collating the product appearing in the registered image with the product appearing in the captured image captured in real time. Therefore, the control device P1 can realize the calculation of the picking position and the generation of the control parameter corresponding to the actual arrangement state of the product Tg, and can improve the picking success probability of the product Tg.

### Technique 7

The control device P1 according to any one of Technique 1 to Technique 6, further includes:
a second acquisition unit (the communication unit 10) configured to acquire the success or failure result of the picking of the object (the product Tg) executed using the control parameter; and
an update unit (the processor 11) configured to accumulate the acquired success or failure result of the picking of the object (the product Tg) in the database (the robot picking continuous improvement database DB2).

Accordingly, the control device P1 can execute additional learning based on the picking result of the product Tg during an operation. That is, the control device P1 can update the picking success probability map MP in real time.

### Technique 8

The control device P1 according to any one of Technique 1 to Technique 7, further includes:
a third acquisition unit (the communication unit 10) configured to acquire the picking position of the object (the product Tg) executed using the control parameter and the success or failure result of the picking of the object (the product Tg); and
an update unit (the processor 11) configured to accumulate the acquired picking position and success or failure result of the picking of the object (the product Tg) intTgthe database (the robot picking continuous improvement database DB2).

Accordingly, the control device P1 can execute the additional learning based on the picking position and the picking result of the product Tg during the operation. That is, the control device P1 can update the picking success probability map MP in real time.

### Technique 9

The control device P1 according to any one of Technique 1 to Technique 8, further includes:
a second acquisition unit (the communication unit 10) configured to acquire the success or failure result of the picking of the object (the product Tg) executed using the control parameter, in which
the calculation unit (the processor 11) calculates a new picking position of the object (the product Tg) different from the picking position of the object (the product Tg) accumulated in the database (the robot picking continuous improvement database DB2) when the success or failure result of the picking of the object (the product Tg) is Tgilure, and
the control unit (the processor 11) outputs a new control parameter based on the new picking position to the robot (the picking robot RB) and causes the robot (the picking robot RB) to execute the picking.

Accordingly, the control device P1 can execute the additional learning based on the picking result of the product Tg during the operation. That is, since the control device P1 can update the picking success probability map MP in real time, the picking operation of the product Tg can be improved in real time.

### Technique 10

In the control device P1 according to any one of Technique 1 to Technique 9,
the calculation unit (the processor 11) calculates the picking position of the object (the product Tg) based on the image, the database (the robot picking continuous improvement database DB2), and weight of the object (the product Tg).

Accordingly, the control device P1 can improve the picking success probability for the product Tg in various arrangement states by generating the control parameter in consideration of the weight of the product Tg and the actual arrangement state of the product Tg without being limited to the picking position where the success probability indicated by the generated picking success probability map MP is high.

### Technique 11

A control method (the picking system 100) for a robot system performed by a computer (the control device P1) that controls a robot (the picking robot RB) that picks an object (the product Tg) and a camera (the 3D camera CM) that captures an image of the object (the product Tg), includes:
acquiring the image (the plurality of RGB images and the plurality of depth images) in which the object (the product Tg) is Tgptured;
storing a database (the robot picking continuous improvement database DB2) in which a plurality of picking positions of the object (the product Tg) and a success or failure result of picking of the object (the product Tg) are accumuTgted for each picking position of the object (the product Tg);
calculating the picking position of the object (the product Tg) based on the imagTgand the database (the robot picking continuous improvement database DB2); and
outputting a control parameter based on the calculated picking position to the robot (the picking robot RB) and causing the robot (the picking robot RB) to execute the picking.

Accordingly, the picking system 100 can generate a control parameter for further increasing the picking success probability based on the picking success probability map MP of the robot picking continuous improvement database DB2.

### Technique 12

A robot control system (the picking system 100) includes:
a robot (the picking robot RB) configured to pick an object (the product Tg);
a camera (the 3D camera CM) configured to capture an image of the object (the product Tg); and
a control device P1 communicable between the robot (the picking robot RB) and the camera (the 3D camera CM), and configured to control the robot (the picking robot RB) and the camera (the 3D camera CM), in which
the control device P1:
acquire the image (the plurality of RGB images and the plurality of depth images) in which the object (the product Tg) is captured,
store a database (the robot picking continuous improvement database DB2) in which a plurality of picking positions of the object (the product Tg) and a success or failure result of picking of the object (the product Tg) areTgccumulated for each picking position of the object (the product Tg),
calculate the picking position of the object (the product Tg) based on the image and the database (the robot picking continuous improvement database DB2); and
output a control parameter based on the calculated picking position to the robot (the picking robot RB) and cause the robot (the picking robot RB) to execute the picking, and
the robot (the picking robot RB) is configured to perform the picking of the object (the product Tg) based on the control parameter.

Accordingly, the picking system 100 can generate the control parameter for further increasing the picking success probability based on the picking success probability map MP of the robot picking continuous improvement database DB2.

Although various embodiments have been described above with reference to the accompanying drawings, the present disclosure is not limited thereto. It is apparent to those skilled in the art that various modifications, corrections, substitutions, additions, deletions, and equivalents can be conceived within the scope described in the claims, and it is understood that such modifications, corrections, substitutions, additions, deletions, and equivalents also fall within the technical scope of the present disclosure. In addition, components in the various embodiments described above may be combined freely in a range without deviating from the spirit of the invention.

What is claimed is:

1. A control device configured to be connected to a robot that picks an object and a camera that captures an image of the object, the control device comprising:
a first acquisition unit configured to acquire the image in which the object is captured;
a recording unit including a database in which a plurality of picking positions of the object and a success or failure result of picking of the object are accumulated for each picking position of the object;
a calculation unit configured to calculate the picking position of the object based on the image and the database; and
a control unit configured to output a control parameter based on the calculated picking position to the robot and cause the robot to execute the picking.

2. The control device according to claim 1, wherein
the calculation unit calculates the picking position of the object based on an arrangement state of the object appearing in the image and the database.

3. The control device according to claim 1, wherein
the database accumulates the plurality of picking positions, a plurality of picking postures of the object, and the success or failure result of the picking of the object for each picking position of the object, and
the calculation unit calculates the picking position of the object and a gripping posture of the object based on the image and the database.

4. The control device according to claim 1, wherein
the robot includes a plurality of different end effectors, and
the calculation unit determines an end effector that picks the object among the plurality of end effectors based on the image and the database.

5. The control device according to claim 1, wherein
the database stores a registered image of the object registered in advance, and
the calculation unit determines the picking position of the object based on a difference between the image and the object appearing in the registered image.

6. The control device according to claim 1, wherein
the control unit outputs an imaging parameter based on the picking position to the camera and causes the camera to capture an image of the picking position.

7. The control device according to claim 1, further comprising:
a second acquisition unit configured to acquire the success or failure result of the picking of the object executed using the control parameter; and
an update unit configured to accumulate the acquired success or failure result of the picking of the object in the database.

8. The control device according to claim 1, further comprising:
a third acquisition unit configured to acquire the picking position of the object executed using the control parameter and the success or failure result of the picking of the object; and
an update unit configured to accumulate the acquired picking position and success or failure result of the picking of the object into the database.

9. The control device according to claim 1, further comprising:
a second acquisition unit configured to acquire the success or failure result of the picking of the object executed using the control parameter, wherein
the calculation unit calculates a new picking position of the object different from the picking position of the object accumulated in the database when the success or failure result of the picking of the object is failure, and
the control unit outputs a new control parameter based on the new picking position to the robot and causes the robot to execute the picking.

10. The control device according to claim 1, wherein
the calculation unit calculates the picking position of the object based on the image, the database, and weight of the object.

11. A control method for a robot system executed by a computer that controls a robot that picks an object and a camera that captures an image of the object, the control method comprising:
acquiring the image in which the object is captured;
storing a database in which a plurality of picking positions of the object and a success or failure result of picking of the object are accumulated for each picking position of the object;
calculating the picking position of the object based on the image and the database; and
outputting a control parameter based on the calculated picking position to the robot and causing the robot to execute the picking.

12. A robot control system comprising:
a robot configured to pick an object;
a camera configured to capture an image of the object; and
a control device communicable between the robot and the camera, and configured to control the robot and the camera, wherein
the control device is configured to:
acquire the image in which the object is captured;
store a database in which a plurality of picking positions of the object and a success or failure result of picking of the object are accumulated for each picking position of the object;
calculate the picking position of the object based on the image and the database; and
output a control parameter based on the calculated picking position to the robot and cause the robot to execute the picking, and
the robot is configured to perform the picking of the object based on the control parameter.
